(19) United States
(12) Patent Application Publication
(10) Pub. No.: US 2024/0405262 A1
(43) Pub. Date: Dec. 5, 2024

(54) ALL SOLID BATTERY

(71) Applicant: TAIYO YUDEN CO., LTD., Tokyo (JP)

(72) Inventor: Takafumi SHIMIZU, Tokyo (JP)

(73) Assignee: TAIYO YUDEN CO., LTD., Tokyo (JP)

(21) Appl. No.: 18/659,721

(22) Filed: May 9, 2024

(30) Foreign Application Priority Data
Jun. 5, 2023 (JP) 2023-092352

(51) Int. Cl. H01M 10/0562; H01M 4/62

(52) U.S. Cl. CPC H01M 10/0562; H01M 4/625; H01M 2300/0071

(57) ABSTRACT

An all solid battery includes a solid electrolyte layer, and an electrode layer that is provided on each of main faces of the solid electrolyte layer and includes an electrode active material and a conductive auxiliary agent. In a frequency distribution of grain size of the conductive auxiliary agent in a cross section of the electrode layer, two largest peaks, a first peak and a second peak, appear in a range of 5 nm or more and 130 nm or less. In a cumulative distribution of the grain size, a portion appears between the first peak and the second peak where a slope is 0.7 or less (%/nm).

### CROSS-REFERENCE TO RELATED APPLICATION

This application is based upon and claims the benefit of priority of the prior Japanese Patent Application No. 2023-092352, filed on Jun. 5, 2023, the entire contents of which are incorporated herein by reference.

### FIELD

A certain aspect of the present invention relates to an all solid battery.

### BACKGROUND

All solid batteries using oxide-based solid electrolytes are expected to be a technology that can provide safe secondary batteries that do not cause ignition or toxic gas generation, which are concerns with organic electrolytes, sulfide-based solid electrolytes, or the like (For example, see Japanese Patent Application Publication No. 2021-034202 and Internal Publication No. 2014/042083).

### SUMMARY OF THE INVENTION

According to an aspect of the present invention, there is provided an all solid battery including: a solid electrolyte layer; and an electrode layer that is provided on each of main faces of the solid electrolyte layer and includes an electrode active material and a conductive auxiliary agent, wherein, in a frequency distribution of grain size of the conductive auxiliary agent in a cross section of the electrode layer, two largest peaks, a first peak and a second peak, appear in a range of 5 nm or more and 130 nm or less, and wherein in a cumulative distribution of the grain size, a portion appears between the first peak and the second peak where a slope is 0.7 or less (%/nm).

### BRIEF DESCRIPTION OF THE DRAWINGS

FIG. 1 illustrates a schematic cross section of a basic structure of an all solid battery;

FIG. 2 illustrates a cross section;

FIG. 3 illustrates a schematic cross section of a stacked all solid battery in which battery units are stacked;

FIG. 4 illustrates a schematic cross section of a stacked all solid battery in which battery units are stacked;

FIG. 5A is a diagram illustrating a frequency distribution of grain size of a conductive auxiliary agent;

FIG. 5B is a diagram illustrating a cumulative distribution;

FIG. 6A is a diagram illustrating a frequency distribution of grain size of a conductive auxiliary agent;

FIG. 6B is a diagram illustrating a cumulative distribution;

FIG. 7A and FIG. 7B are perspective views illustrating a conductive auxiliary agent;

FIG. 7C is a diagram illustrating a stacked cross section of a positive electrode layer;

FIG. 8 illustrates a flowchart of a manufacturing method of an all solid battery; and

FIG. 9A and FIG. 9B illustrate a stacking process.

### DETAILED DESCRIPTION

When a conductive auxiliary agent with a small grain size is used in the electrode layer, electron conduction to each electrode active material becomes good, and good battery operation can be achieved. However, if the grain size is too small, the conductive auxiliary agent may not be able to withstand heat during sintering. When a conductive auxiliary agent having a large grain size is used, the electronic conductivity of the entire electrode layer becomes high, and good battery characteristics can be obtained. However, if the grain size is too large, the ratio of the conductive auxiliary agent required to form each electron conduction path of each electrode active material becomes high, and there is a possibility that high capacity cannot be achieved.

A description will be given of an embodiment with reference to the accompanying drawings.

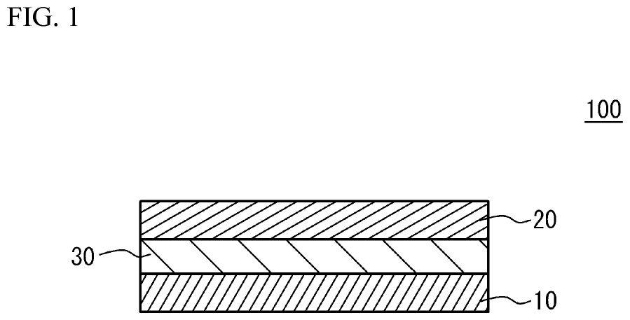

(Embodiment) FIG. 1 illustrates a schematic cross section of a basic structure of an all solid battery 100 in accordance with an embodiment. As illustrated in FIG. 1, the all solid battery 100 has a structure in which a positive electrode layer 10 and a negative electrode layer 20 sandwich a solid electrolyte layer 30. The positive electrode layer 10 is provided on a first main face of the solid electrolyte layer 30. The negative electrode layer 20 is provided on a second main face of the solid electrolyte layer 30. For example, the positive electrode layer 10, the negative electrode layer 20 and the solid electrolyte layer 30 have a sintered body which is formed by sintering powder materials.

A main component of the solid electrolyte layer 30 is a solid electrolyte having ionic conductivity. The solid electrolyte of the solid electrolyte layer 30 is an oxide-based solid electrolyte having lithium ion conductivity. The solid electrolyte is, for example, phosphoric acid salt-based electrolyte having a NASICON crystal structure. For example, the solid electrolyte of the solid electrolyte layer 30 is oxide-based solid electrolyte having lithium ion conductivity. For example, the solid electrolyte is phosphoric acid salt-based electrolyte. The phosphoric acid salt-based solid electrolyte having the NASICON crystal structure has a high conductivity and is stable in normal atmosphere. The phosphoric acid salt-based solid electrolyte is, for example, such as a salt of phosphoric acid including lithium. The phosphoric acid salt is not limited. For example, the phosphoric acid salt is such as composite salt of phosphoric acid with Ti (for example LiTi₂ (PO₄)₃). Alternatively, at least a part of Ti may be replaced with a transition metal of which a valence is four, such as Ge, Sn, Hf, or Zr. In order to increase an amount of Li, a part of Ti may be replaced with a transition metal of which a valence is three, such as Al, Ga, In, Y or La. In concrete, the phosphoric acid salt including lithium and having the NASICON structure is Li₁₊ₓAlₓGe₂₋ₓ(PO₄)₃, Li₁₊ₓAlₓZr₂₋ₓ(PO₄)₃, Li₁₊ₓAlₓT₂₋ₓ(PO₄)₃ or the like. For example, it is preferable that Li—Al—Ge—PO₄-based material, to which a transition metal included in the phosphoric acid salt having the olivine type crystal structure included in the positive electrode layer 10 and the negative electrode layer 20 is added in advance, is used. For example, when the positive electrode layer 10 and the negative electrode layer 20 include phosphoric acid salt including Co and Li, it is preferable that the solid electrolyte layer 30 includes Li—Al—Ge—PO₄-based material to which Co is added in advance. In this case, it is possible to suppress solving of the transition metal included in the electrode active material into the electrolyte. When the positive electrode layer 10 and the negative electrode layer 20 include phosphoric acid salt including Li and a transition metal other than Co, it is preferable that the solid electrolyte layer 30 includes Li—Al—Ge—PO₄-based material in which the transition metal is added in advance.

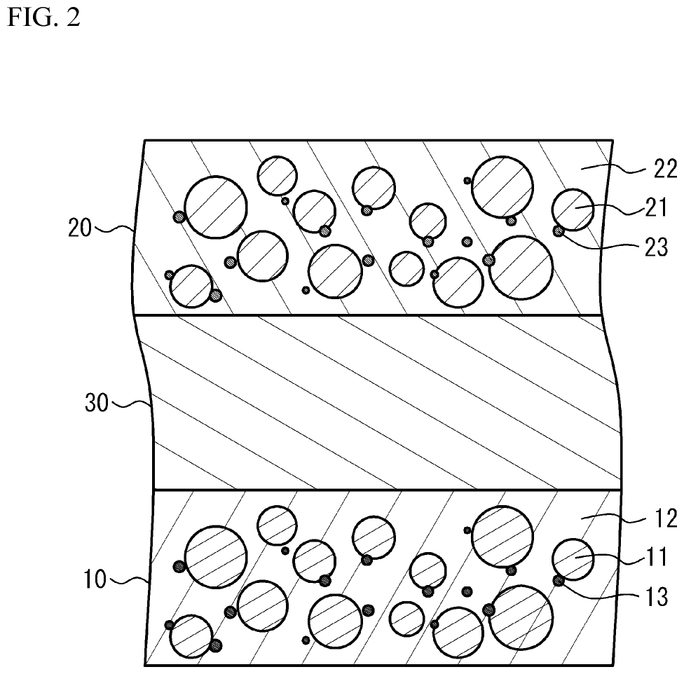

As illustrated in FIG. 2, the positive electrode layer 10 has a structure in which an electrode active material 11, a solid electrolyte 12, a conductive auxiliary agent 13 and so on are dispersed. The negative electrode layer 20 has a structure in which an electrode active material 21, a solid electrolyte 22, a conductive auxiliary agent 23 and so on are dispersed. Since the positive electrode layer 10 includes the electrode active material 11 and the negative electrode layer 20 includes the electrode active material 21, the all solid battery 100 can be used as a secondary battery. Since the positive electrode layer 10 includes the solid electrolyte 12 and the negative electrode layer 20 includes the solid electrolyte 22, ionic conductivity is obtained in the positive electrode layer 10 and the negative electrode layer 20. Since the positive electrode layer 10 includes the conductive auxiliary agent 13 and the negative electrode layer 20 includes the conductive auxiliary agent 23, the positive electrode layer 10 and the negative electrode layer 20 have electrical conductivity.

The electrode active material 11 is, for example, an electrode active material having an olivine crystal structure. The electrode active material having the olivine crystal structure may also be contained in the negative electrode layer 20. The electrode active material is such as phosphoric acid salt including a transition metal and lithium. The olivine type crystal structure is a crystal of natural olivine. It is possible to identify the olivine type crystal structure, by using X-ray diffraction.

For example, LiCoPO₄ including Co may be used as a typical example of the electrode active material having the olivine type crystal structure. Other salts of phosphoric acid, in which Co acting as a transition metal is replaced to another transition metal in the above-mentioned chemical formula, may be used. A ratio of Li or PO₄ may fluctuate in accordance with a valence. It is preferable that Co, Mn, Fe, Ni or the like is used as the transition metal. As the positive electrode active material containing Co and P, LiCo₂P₃O₁₀, Li₂CoP₂O₇, Li₆Co₅ (P₂O₇)₄ or the like can also be used.

For example, when only the positive electrode layer 10 includes the electrode active material having the olivine type crystal structure, the electrode active material acts as the positive electrode active material. When the negative electrode layer 20 also includes an electrode active material having the olivine type crystal structure, discharge capacity may increase and an operation voltage may increase because of electric discharge, in the negative electrode layer 20 acting as the negative electrode. The function mechanism is not completely clear. However, the mechanism may be caused by partial solid-phase formation together with the negative electrode active material.

When both the positive electrode layer 10 and the negative electrode layer 20 include an electrode active material having the olivine type crystal structure, the electrode active material of each of the positive electrode layer 10 and the negative electrode layer 20 may have a common transition metal. Alternatively, the a transition metal of the electrode active material of the positive electrode layer 10 may be different from that of the negative electrode layer 20. The positive electrode layer 10 and the negative electrode layer 20 may have only single type of transition metal. The positive electrode layer 10 and the negative electrode layer 20 may have two or more types of transition metal. It is preferable that the positive electrode layer 10 and the negative electrode layer 20 have a common transition metal. It is more preferable that the electrode active materials of the both electrode layers have the same chemical composition. When the positive electrode layer 10 and the negative electrode layer 20 have a common transition metal or a common electrode active material of the same composition, similarity between the compositions of the both electrode layers increases. Therefore, even if terminals of the all solid battery 100 are connected in a positive/negative reversed state, the all solid battery 100 can be actually used without malfunction, in accordance with the usage purpose.

The negative electrode layer 20 functions as a negative electrode layer by including the electrode active material 21. By containing the negative electrode active material in only one electrode, it becomes clear that the one electrode acts as a negative electrode and the other electrode acts as a positive electrode. However, both electrodes may contain substances known as negative electrode active materials. Conventional technology of secondary batteries may be applied to the negative electrode active material. For example, titanium oxide, lithium-titanium complex oxide, lithium-titanium complex salt of phosphoric acid salt, a carbon, a vanadium lithium phosphate may be used as the negative electrode active material.

The solid electrolyte 12 and the solid electrolyte 22 are not particularly limited as long as they are oxide-based solid electrolytes that have ionic conductivity. The solid electrolyte 12 and the solid electrolyte 22 are, for example, oxide-based solid electrolytes having lithium ion conductivity. The solid electrolyte is, for example, a phosphate solid electrolyte having a NASICON structure. The phosphate-based solid electrolyte is, for example, a phosphate containing lithium. The phosphate is not particularly limited, but includes, for example, a composite lithium phosphate salt with Ti (for example, LiTi₂(PO₄)₃). Alternatively, Ti can be partially or completely replaced with a tetravalent transition metal such as Ge, Sn, Hf, or Zr. Further, in order to increase the Li content, a portion of the metal may be replaced with a trivalent transition metal such as Al, Ga, In, Y, or La. More specifically, examples include Li₁₊ₓAlₓGe₂₋ₓ(PO₄)₃, Li₁₊ₓAlₓZr₂₋ₓ(PO₄)₃, and Li₁₊ₓAlₓTi₂₋ₓ(PO₄)₃. The solid electrolyte 12 and the solid electrolyte 22 can be, for example, the same as the solid electrolyte that is the main component of the solid electrolyte layer 30. Alternatively, when the electrode active material contains Co and P, it is preferable that the solid electrolytes 12 and 22 contain Co. Although the detailed mechanism is unknown, by including Co during co-firing, the oxidation resistance stability of the solid electrolyte tends to improve, thereby easily ensuring cycle stability.

The material of the conductive auxiliary agents 13 and 23 is not particularly limited as long as they have conductivity. However, as an example, a carbon material or the like is used as the material of the conductive auxiliary agents 13 and 23. Metal may be used as the material for the conductive auxiliary agents 13 and 23. Examples of the metal of the conductive auxiliary agent include Pd, Ni, Cu, Fe, or alloys containing these.

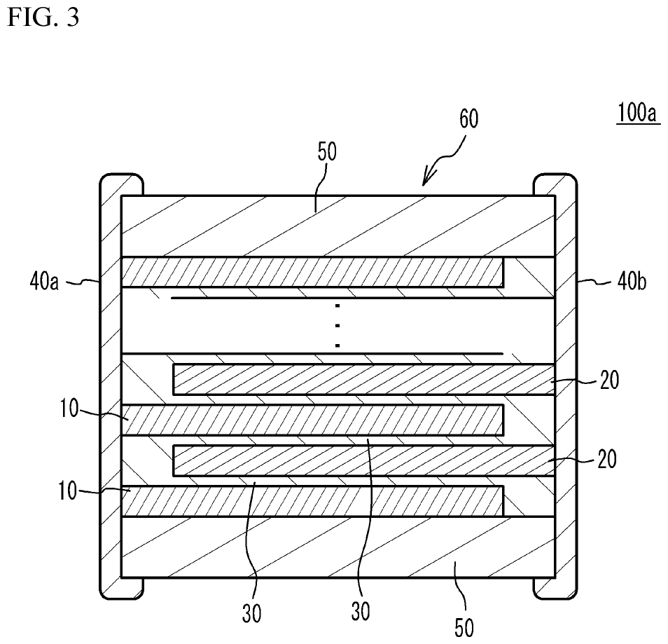

FIG. 3 is a partial cross-sectional perspective view of a stacked all solid battery 100a in which a plurality of battery units are stacked. The all solid battery 100a includes a multilayer chip 60 having a substantially rectangular parallelepiped shape. In the multilayer chip 60, a first external electrode 40a and a second external electrode 40b are provided so as to be in contact with two side faces, which are two of the four faces other than the upper face and the lower face at the ends in the stacking direction. The two side faces may be two adjacent side faces or may be two side faces facing each other. In this embodiment, it is assumed that the first external electrode 40a and the second external electrode 40b are provided so as to be in contact with the two side faces (hereinafter referred to as two end faces) facing each other.

In the following description, the same numeral is added to each member that has the same composition range, the same thickness range and the same particle distribution range as that of the all solid battery 100. And, a detail explanation of the same member is omitted.

In the all solid battery 100a, the plurality of positive electrode layers 10 and the plurality of negative electrode layers 20 are alternately stacked with the solid electrolyte layers 30 in between. The number of the positive electrode layers 10 and the number of the negative electrode layers 20 may be the same as each other. One of the numbers may be larger than the other by one layer. The edges of the plurality of positive electrode layers 10 are exposed to the first end face of the multilayer chip 60 and are not exposed to the second end face. The edges of the plurality of negative electrode layers 20 are exposed to the second end face of the multilayer chip 60 and are not exposed to the first end face. Thereby, the positive electrode layer 10 and the negative electrode layer 20 are alternately electrically connected to the first external electrode 40a and the second external electrode 40b. Note that the solid electrolyte layer 30 extends from the first external electrode 40a to the second external electrode 40b. In this way, the all solid battery 100a has a structure in which a plurality of battery units are stacked.

A cover layer 50 is stacked on the upper surface of the multilayer structure of the positive electrode layer 10, the solid electrolyte layer 30, and the negative electrode layer 20 (in the example of FIG. 3, the upper surface of the uppermost positive electrode layer 10). Further, the cover layer 50 is also stacked on the lower surface of the multilayer structure (in the example of FIG. 3, the lower surface of the lowermost positive electrode layer 10). The cover layer 50 is mainly composed of an inorganic material (for example, Al₂O₃, ZrO₂, TiO₂ or the like) containing Al, Zr, Ti or the like. The cover layer 50 may contain the main component of the solid electrolyte layer 30 as a main component. The cover layer 50 is a sintered body.

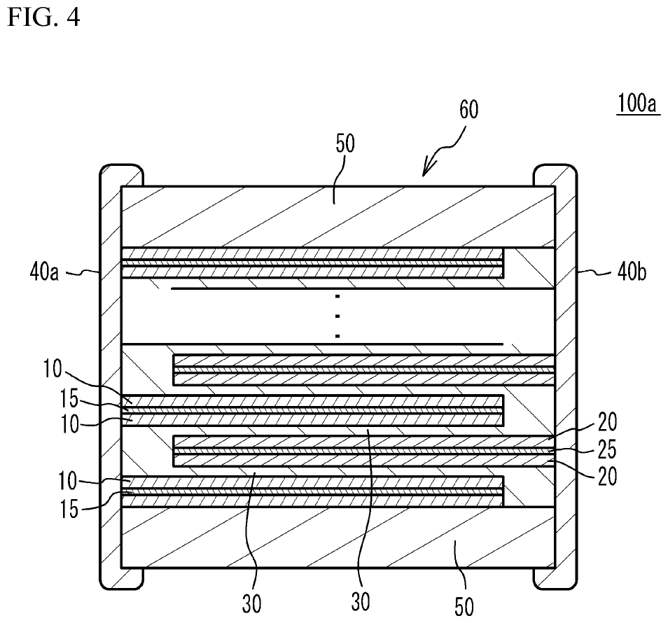

Each of the positive electrode layer 10 and the negative electrode layer 20 may include a current collector layer. For example, as illustrated in FIG. 4, a first current collector layer 15 may be provided within the positive electrode layer 10. Further, a second current collector layer 25 may be provided within the negative electrode layer 20. The first current collector layer 15 and the second current collector layer 25 have a conductive material as a main component. For example, metal, carbon, or the like can be used as the conductive material for the first current collector layer 15 and the second current collector layer 25. By connecting the first current collector layer 15 to the first external electrode 40a and connecting the second current collector layer 25 to the second external electrode 40b, current collection efficiency is improved.

As described above, the positive electrode layer 10 and the negative electrode layer 20 contain a conductive auxiliary agent from the viewpoint of conductivity. For example, when a conductive auxiliary agent with a small grain size is used in the positive electrode layer 10 and the negative electrode layer 20, electron conduction to each electrode active material becomes good, and good battery operation can be realized. However, if the grain size is too small, the conductive auxiliary agent may not be able to withstand heat during sintering. When a conductive auxiliary agent having a large grain size is used, the electronic conductivity of the entire electrode layer becomes high, and good battery characteristics can be obtained. However, if the grain size is too large, the ratio of the conductive auxiliary required to form each electron conduction path of each electrode active material becomes high, and there is a possibility that high capacity cannot be achieved.

Therefore, the all solid batteries 100 and 100a according to the present embodiment have a configuration that can realize good battery operation while keeping the ratio of the conductive auxiliary agent that does not contribute to capacity low.

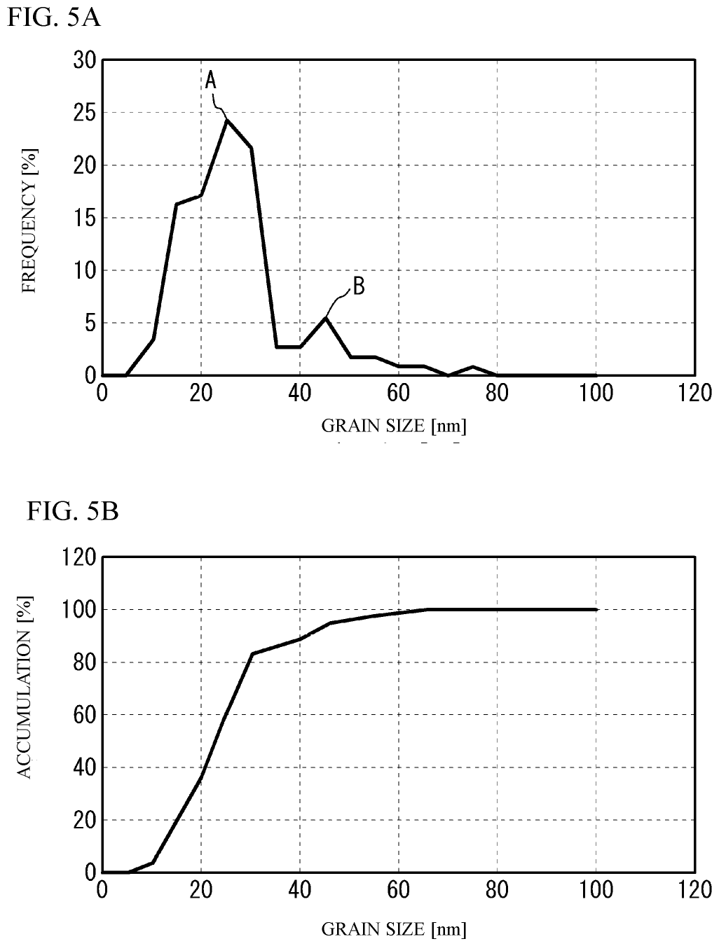

In this embodiment, as the conductive auxiliary agents 13 and 23, both a conductive auxiliary agent with a small grain size and a conductive auxiliary agent with a large grain size are used. Specifically, as illustrated in FIG. 5A, when the frequency distribution of the grain size of the conductive auxiliary agent 13 in a cross section of the positive electrode layer 10 (for example, a cross section including the stacking direction) is calculated, the two largest peaks appear in the range of 5 nm or more and 130 nm or less. Of these two peaks, the one with the smaller grain size is called a first peak A, and the one with the larger grain size is called a second peak B. Furthermore, as illustrated in FIG. 5B, when the cumulative distribution of grain size is calculated, a portion in which the slope between the first peak A and the second peak B is 0.7 or less (%/nm), appears.

For example, in the examples illustrated in FIG. 5A and FIG. 5B, a conductive auxiliary agent with an average grain diameter of 25 nm and a conductive auxiliary agent with an average grain size of 45 nm are mixed at a grain volume ratio of 27:1. In FIG. 5B, the slope of D40% to D80%, which is near the first peak A, is 4.59 (%/nm), which exceeds 0.7. The slope of D88% to D94%, which is near the second peak B, is 0.773 (%/nm), which exceeds 0.7. The slope of D83% to D88% between the first peak A and the second peak B is 0.676 (%/nm), which is 0.7 or less.

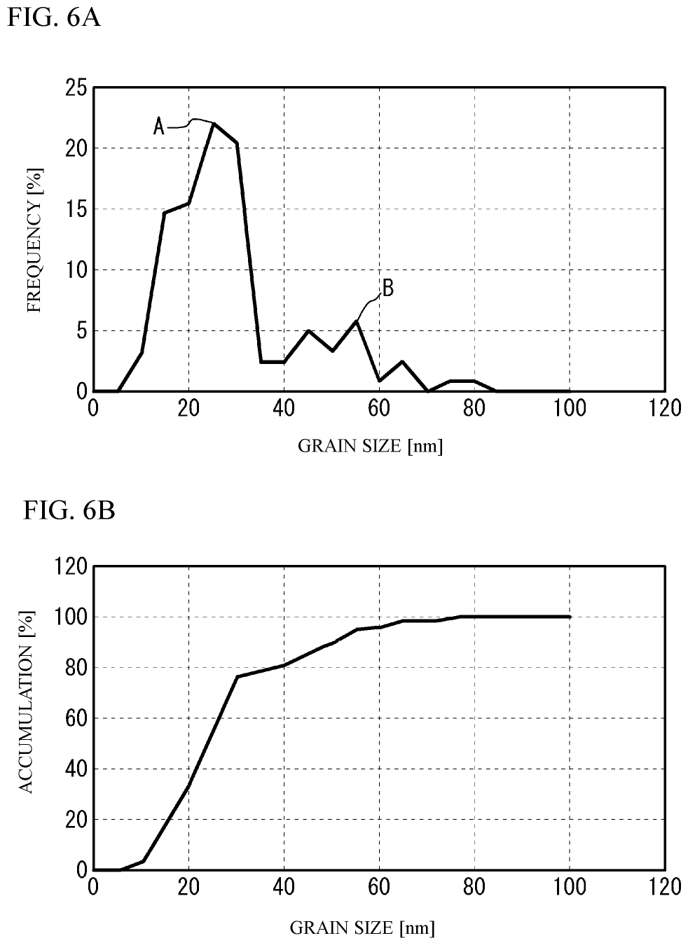

In the examples illustrated in FIG. 6A and FIG. 6B, a conductive auxiliary agent with an average grain diameter of 25 nm and a conductive auxiliary agent with an average grain diameter of 55 nm are mixed at a grain volume ratio of 8:1. In FIG. 6B, the slope of D33% to D76%, which is near the first peak A, is 4.26 (%/nm), which exceeds 0.7. The slope of D82% to D95%, which is near the second peak B, is 0.930 (%/nm), which exceeds 0.7. The slope of D76% to D82% between the first peak A and the second peak B is 0.606 (%/nm), which is 0.7 or less.

Also, when calculating the frequency distribution of the grain size of the conductive auxiliary agent 23 in a cross section of the negative electrode layer 20 (for example, a cross section including the stacking direction), the first peak A and the second peak B are found to be in the range of 5 nm or more and 130 nm or less. Furthermore, when the cumulative distribution of grain size is calculated, a portion appears between the first peak A and the second peak B where the slope is 0.7 (%/nm).

According to this configuration, the conductive auxiliary agent with a small grain size can achieve electron conduction of each electrode active material. Thereby, good battery characteristics can be obtained. Moreover, since the first peak A appears in the range of 5 nm or more and 130 nm or less, the grain size of the conductive auxiliary agent having a small grain size does not become too small. This allows withstanding against heat during sintering. On the other hand, the conductive auxiliary agent having a large grain size achieves electron conduction throughout the electrode layer, resulting in good battery characteristics. Moreover, since the second peak B appears in the range of 5 nm or more and 130 nm or less, the grain size of the conductive auxiliary agent having a large grain size does not become too large. Thereby, the ratio of the conductive auxiliary agent can be suppressed. From the above, it is possible to achieve good battery operation while keeping the ratio of the conductive auxiliary agent that does not contribute to capacity low.

In addition, in the frequency distribution, if the frequency of the first peak A and the second peak B is low, there is a possibility that the effect of the conductive auxiliary agent with a small grain size and the effect of the conductive auxiliary agent with a large grain size cannot be sufficiently obtained. Therefore, it is preferable to set a lower limit on the frequency of the first peak A and the second peak B. For example, the frequency of the first peak A and the second peak B is preferably 3% or more, more preferably 4% or more, and even more preferably 5% or more.

In addition, in the frequency distribution, if the difference between the grain size of the first peak A and the grain size of the second peak B is small, there is a possibility that the effect of the conductive auxiliary agent with a small grain size and the effect of the conductive auxiliary agent with a large grain size are not sufficient. Therefore, it is preferable to set a lower limit to the difference between the grain size of the first peak A and the grain size of the second peak B. For example, the difference between the grain size of the first peak A and the grain size of the second peak B is preferably 10 nm or more, more preferably 15 nm or more, and even more preferably 20 nm or more.

In the positive electrode layer 10, if the amount of the conductive auxiliary agent 13 is small, sufficient conductivity may not be necessarily obtained. And if the amount of the conductive auxiliary agent 13 is large, sufficient capacity may not be necessarily obtained. Therefore, it is preferable to set a lower limit and an upper limit to the amount of the conductive auxiliary agent 13. For example, in the cross section of the positive electrode layer 10, the area ratio of the conductive auxiliary agent 13 with a grain size of 5 nm or more and less than 30 nm is 0.05% or more and less than 4%, and the area of the conductive auxiliary agent 13 with a grain size of 20 nm or more and less than 130 nm is 1% or more and less than 4%. Further, in the cross section of the positive electrode layer 10, it is preferable that the total area ratio of the conductive auxiliary agent 13 is 1.05% or more and less than 8%.

In the negative electrode layer 20, if the amount of the conductive auxiliary agent 23 is small, sufficient conductivity may not be necessarily obtained. And if the amount of the conductive auxiliary agent 23 is large, there is a risk that sufficient capacity may not be obtained. Therefore, it is preferable to set a lower limit and an upper limit to the amount of the conductive auxiliary agent 23. For example, in the cross section of the negative electrode layer 20, it is preferable that the area ratio of the conductive auxiliary agent 23 with a grain size of 5 nm or more and less than 30 nm is 0.05% or more and less than 4%, and the area of the conductive auxiliary agent 23 with a grain size of 20 nm or more and less than 130 nm is 1% or more and less than 4%. Further, in the cross section of the negative electrode layer 20, the total area ratio of the conductive auxiliary agent 23 is preferably 1.05% or more and less than 8%.

The material of the conductive auxiliary agents 13 and 23 is not particularly limited as long as they have conductivity, but is preferably a carbon material. Since the carbon material is soft, it is possible to suppress penetration into the solid electrolyte layer 30. For example, it is preferable to use a fibrous carbon material as the conductive auxiliary agents 13 and 23. In this case, since the width of the conductive auxiliary agents 13 and 23 becomes smaller, it is possible to secure an ion conduction path between the positive electrode layer 10 and the negative electrode layer 20 compared to the case where plate-shaped carbon is used. It is preferable to use carbon nanotubes or the like as the conductive auxiliary agents 13, 23. Since the carbon nanotubes have a hollow fiber shape and are soft, it is possible to suppress the carbon nanotubes from penetrating the solid electrolyte layer 30.

In addition, from the viewpoint of ensuring the content of the electrode active material, in the stacked cross section, the area ratio that the electrode active material 11 occupies in the positive electrode layer 10 and the area ratio that the electrode active material 21 occupies in the negative electrode layer 20 are preferably 30% or more, more preferably 40% or more.

On the other hand, from the viewpoint of ensuring the solid electrolyte content, the area ratio that the electrode active material 11 occupies in the positive electrode layer 10 and the area ratio that the electrode active material 21 occupies in the negative electrode layer 20 are preferably 75% or less, and more preferably 70% or less.

From the viewpoint of suppressing penetration by the conductive auxiliary agents 13 and 23 or the like, the thickness of the solid electrolyte layer 30 is preferably 6 μm or more, and more preferably 7 μm or more.

On the other hand, from the viewpoint of ensuring rate characteristics, the thickness of the solid electrolyte layer 30 is preferably 19 μm or less, and more preferably 18 μm or less.

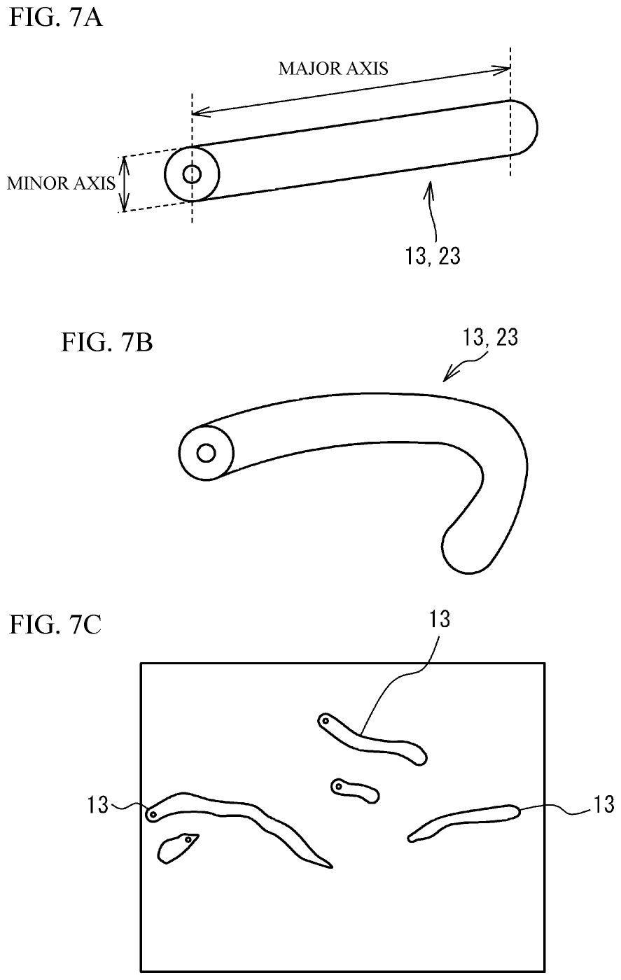

FIG. 7A is a perspective view illustrating the conductive auxiliary agents 13 and 23. As illustrated in FIG. 7A, the conductive auxiliary agents 13 and 23 have, for example, a fibrous shape and have a major axis and a minor axis. The aspect ratio (major axis:minor axis), which is the ratio of the major axis to the minor axis, is preferably 100:1 to 3000:1, more preferably 125:1 to 1000:1, and even more preferably 150:1 to 500:1.

In order to ensure a sufficient conductive distance, the total length of the conductive auxiliary agents 13 and 23 is preferably 1.5 μm or more, more preferably 2.5 μm or more, and even more preferably 5 μm or more.

Note that the conductive auxiliary agents 13 and 23 do not need to extend linearly in the positive electrode layer 10 and the negative electrode layer 20, and may be curved as illustrated in FIG. 7B. Further, when using carbon nanotubes, the hollow portion may be a void or may be filled with another member. In addition, when using a fibrous carbon material, it is preferable to have a grain size of 5 nm or more in order to realize sufficient thermal stability. FIG. 7C is a diagram illustrating a stacked cross section of the positive electrode layer 10. The stacked cross section can be exposed by polishing the all solid battery 100, 100a. Furthermore, the cross section of the stacked layers can be observed using a SEM (scanning electron microscope) or the like. The grain size of the conductive auxiliary agent 13 can be obtained by measuring the shortest diameter passing through the center of gravity of the cross section. The average grain size of the conductive auxiliary agent 23 in the negative electrode layer 20 can also be measured using the same procedure. The area ratio of the conductive auxiliary agent 13 can be determined using, for example, image analysis software (ImageJ Fiji: Schneider, C. A., Rasband, W. S., Elieiri, K. W. “NIH Image to ImageJ: 25 years of image analysis.” Nature Methods 9, 671-675, (2012). The area ratio of the conductive auxiliary agent 13 can be measured by determining the ratio of the cross-sectional area of the conductive auxiliary agent 13 to the total area of the SEM image. The area ratio of the conductive auxiliary agent 23 in the negative electrode layer 20 can also be measured using the same procedure.

The thickness of the solid electrolyte layer 30 can be measured by observing the stacked cross section of the all solid battery 100, 100a with an SEM, measuring the thickness at 10 different points in one layer, and deriving the average value.

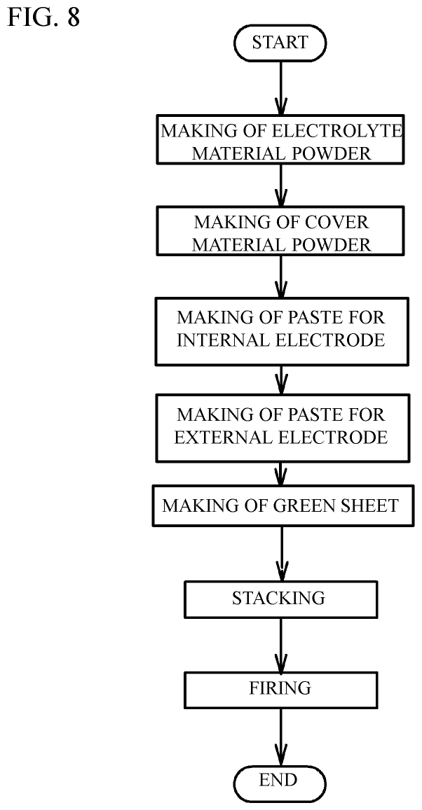

A description will be given of a manufacturing method of the all solid battery 100a described on the basis of FIG. 3. FIG. 8 illustrates a flowchart of the manufacturing method of the all solid battery 100a.

(Making process of raw material powder for solid electrolyte layer) A raw material powder for the solid electrolyte for the solid electrolyte layer 30 is made. For example, it is possible to make the raw material powder for the oxide-based solid electrolyte, by mixing raw material and additives and using solid phase synthesis method or the like. The resulting powder is subjected to dry grinding. Thus, a particle diameter of the resulting power is adjusted to a desired one. For example, it is possible to adjust the particle diameter to the desired diameter with use of planetary ball mill using ZrO₂ ball of 5 mm ϕ. The raw material powder for the oxide-based solid electrolyte does not include the filler material.

(Making process of raw material powder for cover layer) A raw material powder of ceramics for the cover layer 50 is made. For example, it is possible to make the raw material powder for the cover layer, by mixing raw material and additives and using solid phase synthesis method or the like. By dry-pulverizing the obtained raw material powder, it is possible to adjust the obtained material powder to a desired average particle size. For example, the particles are adjusted to a desired average particle size using a planetary ball mill using ZrO₂ balls of 5 mm diameter.

(Making process for electrode layer paste) Next, internal electrode pastes for making the positive electrode layer 10 and the negative electrode layer 20 described above are separately made. For example, the electrode active material and the solid electrolyte material are highly dispersed using a bead mill or the like to produce a ceramic paste consisting only of ceramic particles. The conductive auxiliary agents 13 and 23 are mixed into this ceramic paste. Since fibrous carbon is entangled, the fibrous carbon is dispersed using an ultrasonic homogenizer or a wet jet mill using a paste solvent and an appropriate dispersant. An electrode layer paste can be prepared by mixing the ceramic paste, the dispersion of the conductive auxiliary agents 13 and 23, and the binder.

The sintering assistant includes one or more of glass components such as Li—B—O-based compound, Li—Si—O-based compound, Li—C—O-based compound, Li—S—O-based compound and Li—P—O-based compound.

(Making process of external electrode paste) Next, an external electrode paste for manufacturing the first external electrode 40a and the second external electrode 40b described above is made. For example, a paste for external electrodes can be obtained by uniformly dispersing a conductive material, glass frit, binder, plasticizer and so on in water or an organic solvent.

(Making process of solid electrolyte green sheet) By uniformly dispersing the raw material powder for the solid electrolyte layer in an aqueous or organic solvent together with a binder, dispersant, plasticizer and so on and performing wet pulverization, a solid electrolyte slurry having a desired average particle size can be made. At this time, a bead mill, a wet jet mill, various kneaders, a high-pressure homogenizer, or the like can be used, and it is preferable to use a bead mill from the viewpoint of being able to adjust the particle size distribution and perform dispersion at the same time. A binder is added to the obtained solid electrolyte slurry to obtain a solid electrolyte paste. A solid electrolyte green sheet 51 can be formed by applying the obtained solid electrolyte paste. The coating method is not particularly limited, and a slot die method, reverse coating method, gravure coating method, bar coating method, doctor blade method, or the like can be used. The particle size distribution after wet pulverization can be measured using, for example, a laser diffraction measuring device using a laser diffraction scattering method.

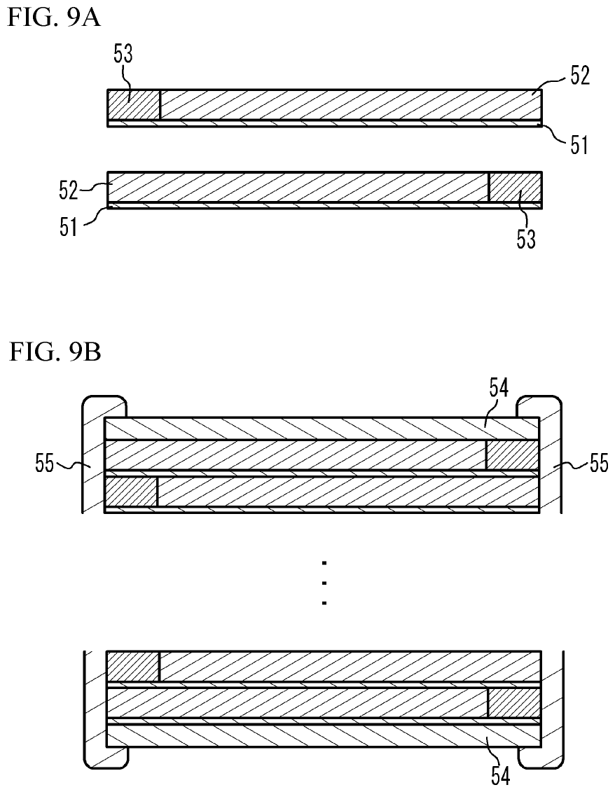

(Stacking process) As illustrated in FIG. 9A, an internal electrode paste 52 is printed on one side of the solid electrolyte green sheet 51. A reverse pattern 53 is printed on the peripheral area of the solid electrolyte green sheet 51 where the internal electrode paste 52 is not printed. The same material for the solid electrolyte green sheet 51 can be used as the reverse pattern 53. The solid electrolyte green sheet 51 after the printing can be used as a stack unit. The plurality of solid electrolyte green sheets 51 are stacked so as to be alternately shifted. As illustrated in FIG. 9B, a multilayer structure is obtained by pressing a cover sheet 54 from above and below in the stacking direction. In this case, in the multilayer structure, the internal electrode paste 52 for the positive electrode layer 10 is exposed on one end surface, and the internal electrode paste 52 for the negative electrode layer 20 is exposed on the other end surface. The cover sheet 54 can be formed by applying the raw material powder for the cover layer using a method similar to the making process of the solid electrolyte green sheet. The cover sheet 54 is formed thicker than the solid electrolyte green sheet 51. The thickness may be increased at the time of coating, or by stacking a plurality of coated sheets.

Next, an eternal electrode paste 55 is applied to two end faces of the multilayer structure by dipping or the like and is dried. Thus, a compact for forming the all solid battery 100a is obtained.

(Firing process) Next, the resulting ceramic multilayer structure is fired. The firing conditions are not particularly limited, such as under an oxidizing atmosphere or a non-oxidizing atmosphere, with a maximum temperature of preferably 400° C. to 1000° C., more preferably 500° C. to 900° C. In order to sufficiently remove the binder before the maximum temperature is reached, a step of maintaining the temperature lower than the maximum temperature in an oxidizing atmosphere may be provided. In order to reduce process costs, it is desirable to fire at as low a temperature as possible. After firing, re-oxidation treatment may be performed. Through the processes, the all solid battery 100a is formed.

By sequentially stacking the internal electrode paste, the current collector paste containing a conductive material, and the internal electrode paste, a current collector layer can be formed in the positive electrode layer 10 and the negative electrode layer 20.

### EXAMPLES

(Examples 1 to 5) The electrode active material and solid electrolyte were highly dispersed using a bead mill to produce a ceramic paste consisting only of ceramic particles. Carbon nanotubes were used as the conductive auxiliary agent. Since carbon nanotubes were entangled, they were dispersed using an ultrasonic homogenizer or a wet jet mill using a paste solvent and an appropriate dispersant. The conditions of the dispersion treatment were adjusted so that the aspect ratio of the fiber size of the carbon nanotubes was 100:1 to 1000:1. An electrode paste was prepared by mixing ceramic paste, carbon nanotube dispersion, and binder. Thereafter, an electrode paste was printed on the solid electrolyte layer, stacked, and fired to form external electrodes to produce an all solid battery. In each of Examples 1 to 5, the amount and particle size of the conductive auxiliary agent were adjusted.

The cross section of the battery after sintering was polished by ion milling, and SEM observation was performed to determine the grain size and the area ratio of each conductive auxiliary agent contained in the electrode layer. Regarding the grain size, frequency distribution and cumulative distribution were calculated. In the frequency distributions of Examples 1 to 5, the two largest peaks, the first peak A and the second peak B, appeared in the range of 5 nm or more and 130 nm or less. Further, in the cumulative distribution, a portion appeared between the first peak A and the second peak B where the slope was 0.7 or less (%/nm).

In Example 1, the grain size of the first peak A was 25 nm, and the frequency of the first peak A was 24%, and the grain size of the second peak B was 45 nm, and the frequency of the second peak B was 5.4%. The minimum slope between the first peak A and the second peak B was 0.67. In Example 2, the grain size of the first peak A was 25 nm, and the frequency of the first peak A was 22%, and the grain size of the second peak B was 55 nm, and the frequency of the second peak B was 5.7%. The minimum slope between the first peak A and the second peak B was 0.61. In Example 3, the grain size of the first peak A was 25 nm, the frequency of the first peak A was 8.7%, the grain size of the second peak B was 65 nm, and the frequency of the second peak B was 9.9%. The minimum slope between the first peak A and the second peak B was 0.49. In Example 4, the grain size of the first peak A was 20 nm, the frequency of the first peak A was 5.0%, the grain size of the second peak B was 66 nm, and the frequency of the second peak B was 7.5% The minimum slope between the first peak A and the second peak B was 0.53. In Example 5, the grain size of the first peak A was 25 nm, and the frequency of the first peak A was 22%, and the grain size of the second peak B was 55 nm, and the frequency of the second peak B was 5.7%. The minimum slope between the first peak A and the second peak B was 0.61.

In Example 1, the area ratio of the conductive auxiliary agent with a grain size of 5 nm or more and less than 30 nm was 3.5%, and the area ratio of the conductive auxiliary agent with a grain size of 20 nm or more and less than 130 nm was 1.0%. In Example 2, the area ratio of the conductive auxiliary agent having a grain size of 5 nm or more and less than 30 nm was 3.5%, and the area ratio of the conductive auxiliary agent having a grain size of 20 nm or more and less than 130 nm was 3.5%. In Example 3, the area ratio of the conductive auxiliary agent having a grain size of 5 nm or more and less than 30 nm was 0.2%, and the area ratio of the conductive auxiliary agent having a grain size of 20 nm or more and less than 130 nm was 3.0%. In Example 4, the area ratio of the conductive auxiliary agent having a grain size of 5 nm or more and less than 30 nm was 0.05%, and the area ratio of the conductive auxiliary agent having a grain size of 20 nm or more and less than 130 nm was 1.0%. In Example 5, the area ratio of the conductive auxiliary agent having a grain size of 5 nm or more and less than 30 nm was 5.0%, and the area ratio of the conductive auxiliary agent having a grain size of 20 nm or more and less than 130 nm was 5.0%.

(Comparative Example 1) In Comparative Example 1, only one peak 1 appeared in the range of 5 nm or more and 130 nm or less in the frequency distribution of the grain size of the conductive auxiliary agent. The area ratio of the conductive auxiliary agent having a grain size of 5 nm or more and less than 30 nm was 3.0%, and the area ratio of the conductive auxiliary agent having a grain size of 20 nm or more and less than 130 nm was 0%. Other conditions were the same as in Example 1.

(Comparative Example 2) In Comparative Example 2, only one peak 1 appeared in the range of 5 nm or more and 130 nm or less in the frequency distribution of the grain size of the conductive auxiliary agent. The area ratio of the conductive auxiliary agent having a grain size of 5 nm or more and less than 30 nm was 0%, and the area ratio of the conductive auxiliary agent having a grain size of 20 nm or more and less than 130 nm was 3.0%. Other conditions were the same as in Example 1.

(Evaluation of battery characteristics) Battery characteristics were evaluated for each of Examples 1 to 5 and Comparative Examples 1 and 2. The battery characteristics were evaluated by CC charging/discharging measurements at 25° C. (charging current: 0.2C and discharge current: 0.2C or charging current: 1C and discharge current: 1C, cut voltage upper limit: 3.6V, lower limit: 1.5V). For rate characteristics, the ratio of 1C discharge capacity when 0.2C discharge capacity was 100% was calculated. If the ratio was 70% or more, it was judged as very good “o”. If the ratio was 60% or more, it was judged as good “A”. If the ratio was less than 60%, it was judged as bad “x”. Capacity values were compared based on 0.2C discharge capacity. When the discharge capacity of Example 2 was taken as 100%, the ratio of the discharge capacity value of each battery was determined, and when the ratio was 90% or more, it was judged as very good “o”. If the ratio was 80% or more, it was judged as good “A”, and if the ratio was less than 80%, it was judged as bad “x

(Cycle Characteristics) Additionally, the cycle characteristics of each of Examples 1 to 5 and Comparative Examples 1 and 2 were investigated. Specifically, charging and discharging was performed at 1C in a voltage range of 3.6V to 1.5V at 25° C. If the value of discharge capacity after 100 cycles was 80% or more of the initial discharge capacity, it was judged as very good “o”. If the value was 60% or more, it was judged as good “A”. If the value was 60% or less, it was judged as bad “x”.

The results are shown in Table 1. In Examples 1 to 5, none of the rate characteristics, capacity, and cycle characteristics were judged as bad. This means that in the frequency distribution of the grain size of the conductive auxiliary agent, the two largest peaks, the first peak A and the second peak B, appeared in the range from 5 nm to 130 nm, and in the cumulative distribution of the grain size, a portion where the slope was 0.7 or less (%/nm) appeared between the first peak A and the second peak B. In Comparative Example 1, the rate characteristics were judged as bad “x”. This is thought to be because a conductive auxiliary agent with a relatively large grain size was not included, and the conductivity of the entire electrode layer was low. In Comparative Example 2, the capacity and cycle characteristics were judged as bad “x”. This is thought to be because a conductive auxiliary agent with a relatively small grain size was not included, resulting in insufficient conductive paths for each electrode active material.

TABLE 1

| | | | | | | AREA RATIO | | | | |
|---|---|---|---|---|---|---|---|---|---|---|
| | | | | | | OF CONDUCTIVE | | | | |
| | | | | | | AUXILIARY | | | | |
| | | | | | | 5 nm TO | 20 nm TO | | | |
| | FIRST | | SECOND | | MINIMUM | LESS | LESS | | | |
| | PEAK | | PEAK | | SLOPE | THAN | THAN | RATE | | CYCLE |
| | (nm) | (%) | (nm) | (%) | (%/nm) | 30 nm | 130 nm | CHARACTERISTIC | CAPACITY | CHARACTERISTIC |
| EXAMPLE 1 | 25 | 24 | 45 | 5.4 | 0.67 | 3.5 | 1.0 | ◯ | ◯ | ◯ |
| EXAMPLE 2 | 25 | 22 | 55 | 5.7 | 0.61 | 3.5 | 3.5 | ◯ | ◯ | ◯ |
| EXAMPLE 3 | 25 | 8.7 | 65 | 9.9 | 0.49 | 0.2 | 3.0 | ◯ | ◯ | ◯ |
| EXAMPLE 4 | 20 | 5.0 | 66 | 7.5 | 0,53 | 0.05 | 1.0 | ◯ | ◯ | ◯ |
| EXAMPLE 5 | 25 | 22 | 55 | 5.7 | 0.61 | 5.0 | 5.0 | ◯ | Δ | ◯ |
| COMPARATIVE | — | — | — | — | — | 3.0 | 0 | X | Δ | Δ |
| EXAMPLE 1 | | | | | | | | | | |
| COMPARATIVE | — | — | — | — | — | 0 | 3.0 | Δ | X | X |
| EXAMPLE 2 | | | | | | | | | | |

Although the embodiments of the present invention have been described in detail, it is to be understood that the various change, substitutions, and alterations could be made hereto without departing from the spirit and scope of the invention.

What is claimed is:

1. An all solid battery comprising:
a solid electrolyte layer; and
an electrode layer that is provided on each of main faces of the solid electrolyte layer and includes an electrode active material and a conductive auxiliary agent,
wherein, in a frequency distribution of grain size of the conductive auxiliary agent in a cross section of the electrode layer, two largest peaks, a first peak and a second peak, appear in a range of 5 nm or more and 130 nm or less, and
wherein in a cumulative distribution of the grain size, a portion appears between the first peak and the second peak where a slope is 0.7 or less (%/nm).

2. The all solid battery as claimed in claim 1, wherein, in the frequency distribution, a frequency of the first peak and the second peak is 5% or more.

3. The all solid battery as claimed in claim 1, wherein a difference between a grain size of the first peak and a grain size of the second peak is 20 nm or more.

4. The all solid battery as claimed in claim 1,
wherein, in the cross section of the electrode layer, an area ratio of the conductive auxiliary agent with a grain size of 5 nm or more and less than 30 nm is 0.05% or more and less than 4%, and
wherein, in the cross section of the electrode layer, an area ratio of the conductive auxiliary agent with a grain size of 20 nm or more and less than 130 nm is 1% or more and less than 4%.

5. The all solid battery as claimed in claim 1, wherein a total area ratio of the conductive auxiliary agent in the cross section of the electrode layer is 1.05% or more and less than 8%.

6. The all solid battery as claimed in claim 1, wherein the conductive auxiliary agent is a carbon material.

7. The all solid battery as claimed in claim 6, wherein the carbon material is a fibrous carbon material.

8. The all solid battery as claimed in claim 6, wherein the carbon material is a carbon nanotube.

9. The all solid battery as claimed in claim 1, wherein the solid electrolyte layer is an oxide.

10. The all solid battery as claimed in claim 1, wherein the solid electrolyte layer is a phosphate oxide.

11. The all solid battery as claimed in claim 1, wherein the solid electrolyte layer and the electro layer are a sintered body.
